(19) United States
(12) Patent Application Publication
(10) Pub. No.: US 2026/0167434 A1
(43) Pub. Date: Jun. 18, 2026

(54) FEED HOPPER

(71) Applicant: Hazemag & EPR GmbH, Dülmen (DE)

(72) Inventors: Felix Borgers, Haltern am See (DE); Florian Lewe, Dülmen (DE)

(73) Assignee: Hazemag & EPR GmbH, Dülmen (DE)

(21) Appl. No.: 19/393,797

(22) Filed: Nov. 19, 2025

(30) Foreign Application Priority Data
Dec. 10, 2024 (EP) 24 218 719.3

(51) Int. Cl. B65G 47/20

(52) U.S. Cl. CPC B65G 47/20

(57) ABSTRACT

The invention relates to a feed hopper (1) for a material processing machine with hopper walls (2) which are mounted so as to be movable in a working position and a transport position, wherein each of the hopper walls (2) is assigned at least one hopper wall adjusting device (3), wherein the at least one hopper wall adjusting device (3) has at least one frame (4), a drive device (6) mounted so as to be movable on the at least one frame (4), and a lever system (7) designed to move the associated hopper wall (2), which lever system is mounted so as to be movable in a self-locking position and a folding position on the at least one frame (4), wherein the drive device (6) is connected to the lever system (7) in a movement-coupled manner, and the drive device (6) is designed to move the lever system (7) into the self-locking position and/or into the folding position, and wherein in the working position of the hopper wall (2), the lever system (7) is arranged in the self-locking position and the lever system (7) is designed to hold the hopper wall (2) in a self-locking manner in the working position.

The invention relates to a feed hopper for a material processing machine with multiple hopper walls, each of which is movably mounted in a working position in which the hopper walls are arranged to enable the receiving and feeding of material to be processed, and a transport position in which the hopper walls are arranged on the material processing machine in a compact, folded-away manner for transport.

Known material processing machines are typically used for feeding, conveying, crushing, screening or washing material, such as mineral raw materials. These known material processing machines comprise, for example, a feed hopper, a conveyor belt, a crusher, a screen or a corresponding device for transferring, refining or sorting minerals. Such material processing machines can be designed as mobile machines so that they can be moved between different workstations or at least within a workstation. In order to reduce the height of the material processing machines, it is therefore known that the hopper walls are mounted so as to be movable between a working position, in which the hopper walls are arranged to enable the receiving and feeding of material to be processed, and a transport position, in which the hopper walls are arranged on the material processing machine in a compact, folded-away manner for transport. The movable mounting of the hopper walls and in particular the arrangement in the working position still represents a major problem due to the heavy stress on the hopper walls. In addition to the high weight of the fed material that hits the hopper walls when loading the feed hopper, the bucket of an excavator used for loading can also accidentally hit the hopper walls, so that the hopper walls have to withstand great forces in the working position. These requirements contradict the requirement that the hopper walls must be movable for the transport of the material processing machine. This is because mobility requires appropriate support of the hopper walls, which contradicts a stable arrangement of the hopper walls in the working position.

The invention is based on the object of creating a solution which provides a feed hopper in a structurally simple and cost-effective manner, which avoids the above-mentioned disadvantages and solves the above-mentioned problems and which ensures a safe and stable arrangement of the hopper walls in the working position.

This object is achieved according to the invention by a feed hopper for a material processing machine with the features according to claim 1.

The feed hopper according to the invention for a material processing machine has multiple hopper walls, each of which is movably mounted in a working position, in which the hopper walls are arranged to enable the receiving and feeding of material to be processed, and a transport position, in which the hopper walls are arranged on the material processing machine in a compact, folded-away manner for transport. Each of the hopper walls is assigned at least one hopper wall adjusting device, wherein the at least one hopper wall adjusting device has at least one frame, a drive device movably mounted on the at least one frame, and a lever system designed to move the associated hopper wall, which lever system is movably mounted on the at least one frame in a self-locking position and a folding position. Furthermore, the drive device is connected to the lever system in a movement coupled manner or is drive-connected, wherein the drive device is designed to move the lever system into the self-locking position and/or into the folding position. In the working position of the hopper wall, the lever system is arranged in the self-locking position, wherein the lever system is designed to hold the hopper wall in the working position in a self-locking manner. For the purposes of the invention, the term “self-locking” means that the lever system is blocked in the self-locking position and maintains its position even when a load is applied to the lever system. The frame can be designed to be attachable to the material processing machine or can be designed as part of the material processing machine or the chassis of the material processing machine.

Advantageous and expedient embodiments and developments of the invention are disclosed in the corresponding dependent claims.

The invention provides a feed hopper for a material processing machine which is distinguished by a compact design and with which the disadvantages and problems known from the prior art are avoided and solved. Since the lever system of the hopper wall adjusting device assumes a self-locking position in the working position of the hopper walls, a safe and stable arrangement of the hopper walls in the working position is ensured with the aid of the feed hopper according to the invention.

It is particularly advantageous in an embodiment of the invention if the hopper wall has its own weight, wherein in the working position the hopper wall is designed to urge the lever system into the self-locking position with its own weight. The own weight or dead weight of the hopper wall is used to hold the lever system in the self-locking position, which at the same time holds the hopper wall itself in the working position.

In order to achieve a low energy expenditure for moving a respective hopper wall, the invention provides in a further embodiment that the lever system is designed to exceed an extended position when moving from the self-locking position into the folding position or from the folding position into the self-locking position. At the same time, the presence of an extended position results in a stable locking of the lever system both in the self-locking position and in the folding position.

For safety reasons, in order to avoid an unintentional movement of the hopper wall beyond the extended position or an unintentional passing through the extended position, the invention provides in a further embodiment that the lever system has a resistance element which is designed to allow passing through or exceeding the extended position against a resistance force exerted by the resistance element.

With a view to a compact and space-saving design, it is provided in an embodiment of the invention that the lever system has a first lever element and a second lever element, wherein the first lever element and the second lever element are designed to be movable relative to one another and are connected to one another in an articulated manner, and wherein the second lever element is connected to the frame in an articulated manner and the first lever element is connected to the hopper wall.

For a stable position of the hopper wall both in the working position and in the transport position, it is advantageous in an embodiment of the invention if, during a movement from the self-locking position to the folding position and/or from the folding position to the self-locking position, the first lever element and the second lever element are designed and mounted so as to exceed a dead center.

For a defined exceeding of the dead center, it is provided in a further embodiment of the invention that the first lever element is designed to be adjustable in its longitudinal extent and that the first lever element has a greater longitudinal extent in the self-locking position and in the folding position than in the dead center.

For safety reasons and for the defined exceeding of the dead center, the invention provides in a further embodiment that the first lever element has a counterforce element which is designed to allow the dead center to be exceeded during a movement from the self-locking position into the folding position and/or from the folding position into the self-locking position against a counterforce exerted by the counterforce element.

Accordingly, in a further embodiment of the invention, it is provided that the counterforce element is designed to allow adjustment of the longitudinal extent of the first lever element against the counterforce exerted by the counterforce element.

In an embodiment of the invention, it is particularly advantageous and structurally simple if the counterforce element has an elastic spring element.

For the secure positioning of a respective hopper wall, it is provided in an embodiment of the invention that the first lever element and/or the second lever element is/are arranged in the self-locking position, supported at least in sections, against a support.

For a variable alignment of the inclination of a respective hopper wall in the working position, the invention provides in an embodiment that the support is adjustably mounted.

In order to generate large forces for moving a hopper wall while maintaining a compact design, the invention provides that the drive device is designed as a hydraulic cylinder which acts on the first lever element and/or the second lever element. “Engaging” in the sense of the invention means that the hydraulic cylinder is drivingly connected to the first lever element and/or the second lever element and the first lever element and/or the second lever element is designed to be moving. Alternatively, the hydraulic cylinder can also act on a hinge point via which the first lever element and the second lever element are connected to each other in an articulated manner.

With regard to a compact arrangement during transport, the invention provides in a further embodiment that in the folding position the first lever element and the second lever element are folded together and arranged having an enclosed angle of less than 90°. In this arrangement of the first lever element and the second lever element, the hopper wall is folded away in order to reduce the height of the material processing machine to a minimum.

In an embodiment of the invention, a particularly compact folding of the two lever elements is possible in that, during a movement from the folding position into the self-locking position and/or from the self-locking position into the folding position, a direction of rotation of the first lever element is opposite to a direction of rotation of the second lever element.

Finally, in a further embodiment, the invention provides that the hopper walls have side edges which are arranged adjacent to one another in the working position, wherein locking means are formed on the side edges of two hopper walls arranged adjacent to one another, which locking means are designed to engage with one another in the working position and to hold the two hopper walls arranged adjacent to one another in a locking manner in the working position. The two hopper walls arranged adjacent to each other can form a corner of the feed hopper, wherein the locking means can comprise wedges, bolts or catch hooks.

It goes without saying that the features mentioned above and those to be explained below can be used not only in the specified combination, but also in other combinations or in isolation, without departing from the scope of the present invention. The scope of the invention is defined only by the claims.

Other details, features, and advantages of the subject matter of the invention can be found in the following description in conjunction with the drawings, in which an exemplary preferred embodiment of the invention is shown:

In the drawing:

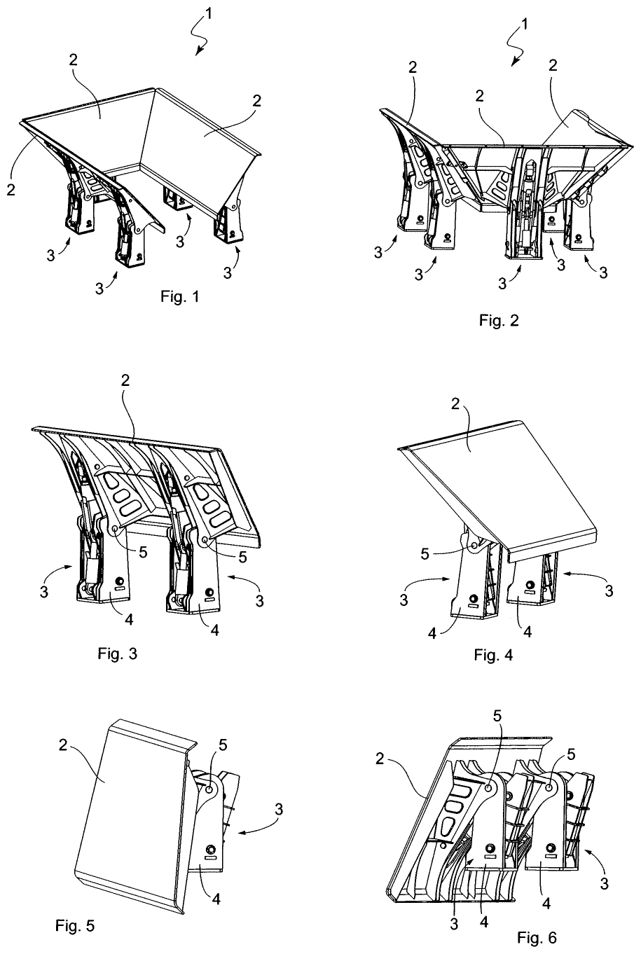

FIG. 1 shows a perspective view of a feed hopper according to the invention,

FIG. 2 shows a further perspective view of the feed hopper according to the invention,

FIG. 3 shows a perspective view of a hopper wall of the feed hopper according to the invention arranged in a working position,

FIG. 4 shows a further perspective view of the hopper wall of the feed hopper according to the invention shown in FIG. 3 and arranged in the working position,

FIG. 5 shows a perspective view of the hopper wall of the feed hopper according to the invention arranged in a transport position,

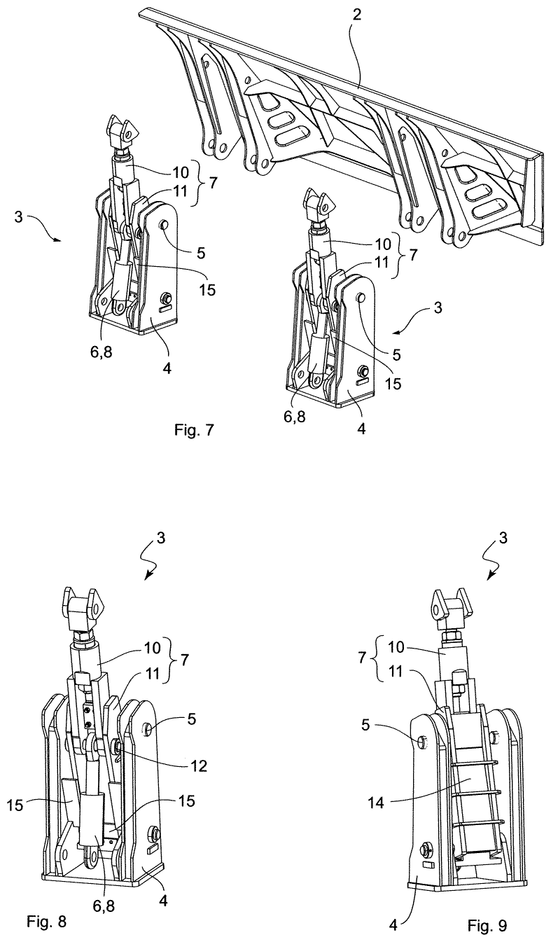

FIG. 6 shows a further perspective view of the hopper wall of the feed hopper according to the invention shown in FIG. 5 and arranged in the transport position,

FIG. 7 shows a perspective exploded view of the hopper wall and two hopper wall adjusting devices of the feed hopper according to the invention,

FIG. 8 shows a perspective front view of a hopper wall adjusting device of the feed hopper according to the invention,

FIG. 9 shows a perspective rear view of the hopper wall adjusting device of the feed hopper according to the invention,

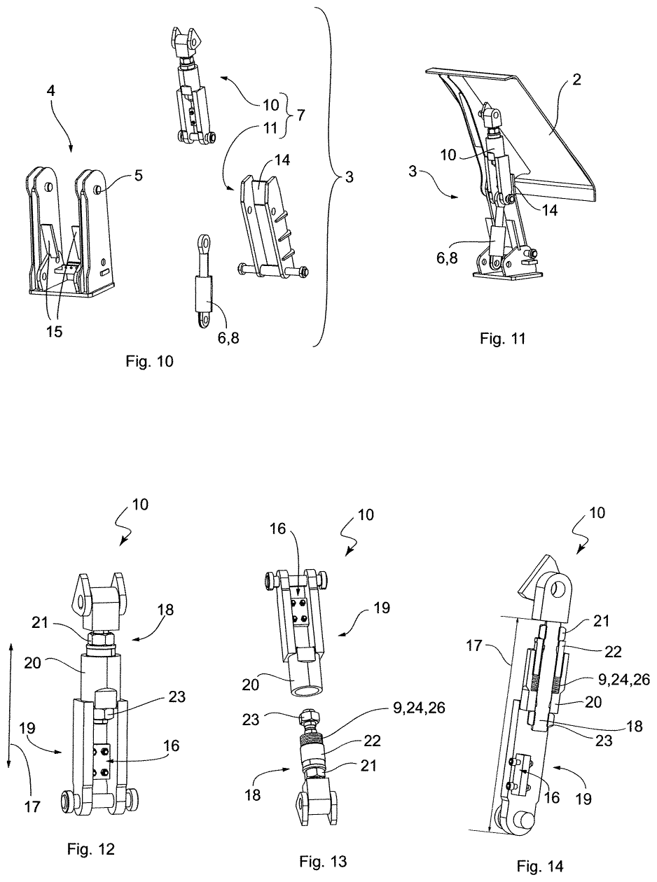

FIG. 10 shows a perspective view of individual parts of the hopper wall adjusting device,

FIG. 11 shows a perspective view of the hopper wall adjusting device, wherein a frame of the hopper wall adjusting device is hidden.

FIG. 12 shows a perspective view of a lever element of the hopper wall adjusting device,

FIG. 13 shows a further perspective view of the lever element of the hopper wall adjusting device shown in FIG. 11,

FIG. 14 shows a perspective sectional view of the lever element of the hopper wall adjusting device,

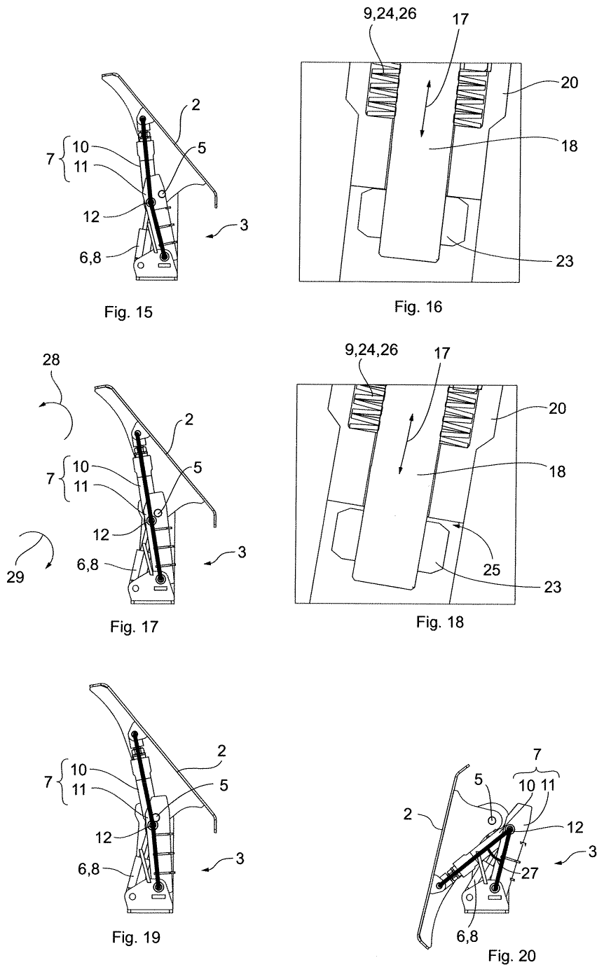

FIG. 15 shows a side view of a hopper wall arranged in the working position and of a hopper wall adjusting device,

FIG. 16 shows an enlarged sectional view of a lever element of the hopper wall adjusting device from FIG. 14,

FIG. 17 shows a side view of a hopper wall arranged between the working position and the transport position and of a hopper wall adjusting device with a lever system arranged in an extended position,

FIG. 18 shows an enlarged sectional view of a lever element of the hopper wall adjusting device from FIG. 16,

FIG. 19 shows a side view of a hopper wall arranged between the working position and the transport position and of a hopper wall adjusting device with a lever system which has passed through the extended position,

FIG. 20 shows a side view of a hopper wall arranged in the transport position and of a hopper wall adjusting device,

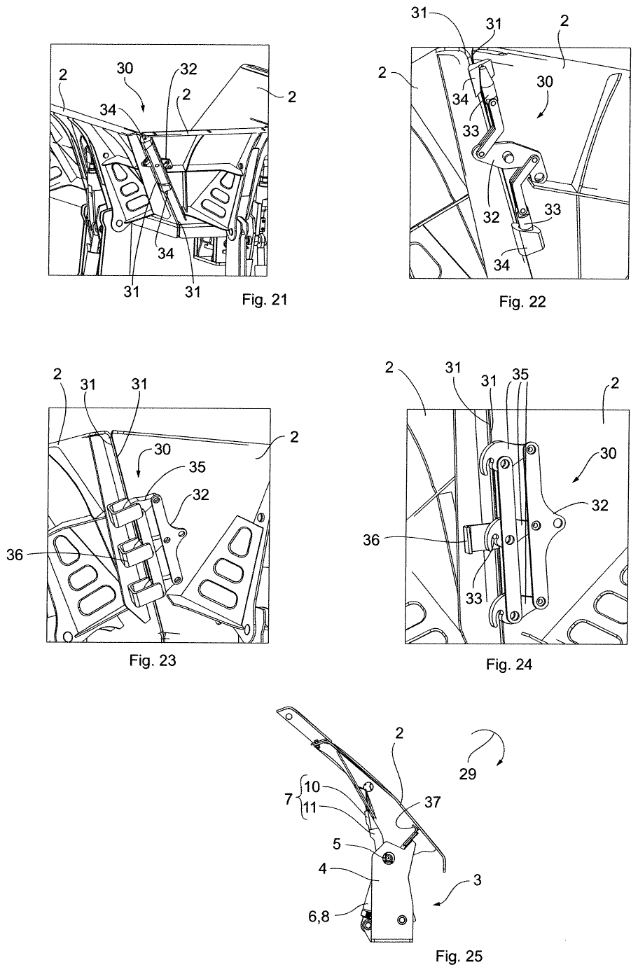

FIG. 21 shows an enlarged perspective view of two hopper walls arranged in their working position, which are engaged with each other by locking means designed in the manner of a bolt,

FIG. 22 shows a further enlarged perspective view of the locking means from FIG. 21,

FIG. 23 shows an enlarged perspective view of two hopper walls arranged in their working position, which are engaged with each other by locking means designed in the manner of a catch hook,

FIG. 24 shows a further enlarged perspective view of the locking means from FIG. 23, and

FIG. 25 shows a development of the hopper wall adjusting device with a safety stop for a hopper wall.

FIGS. 1 and 2 show a feed hopper 1 according to the invention for a material processing machine in different perspective views. The feed hopper 1 has multiple hopper walls 2, wherein in the embodiment shown in the figures the feed hopper 1 comprises a total of three hopper walls 2. Each hopper wall 2 is mounted so as to be movable into a working position and into a transport position, wherein the hopper walls 2 in FIGS. 1 and 2 are arranged in the working position in which the hopper walls 2 are arranged so as to enable the receiving and feeding of material to be processed. In the transport position, however, the hopper walls 2 are arranged on the material processing machine in a compact manner for transport and folded away. Each of the hopper walls 2 is assigned at least one hopper wall adjusting device 3 designed to move a respective hopper wall 2. As can be seen from FIGS. 1 and 2, two hopper wall adjusting devices 3 are each assigned to the two hopper walls 2 arranged parallel to one another, whereas a single hopper wall adjusting device 3 is assigned to the front-side hopper wall 2 arranged between the two hopper walls 2 arranged in parallel. A respective hopper wall adjusting device 3 is designed such that it moves the assigned hopper wall 2 from the transport position into the working position or from the working position into the transport position.

FIGS. 3 to 6 show a hopper wall 2 to which two hopper wall adjusting devices 3 are assigned. In the following description, the structure is described for a single hopper wall adjusting device 3, wherein it is clear that the description of the structure refers to each individual hopper wall adjusting device 3 shown in FIGS. 1 and 2, since all hopper wall adjusting devices 3 are identically designed.

The hopper wall adjusting device 3 has at least one frame 4, wherein the hopper wall 2 is pivotably mounted on the frame 4 via a pivot axis 5, as can be seen from FIGS. 3 to 6. The frame 4 can be designed to be attachable to the material processing machine, wherein it is also conceivable that the frame 4 is designed as part of the material processing machine or a chassis of the material processing machine. FIGS. 3 and 4 show different perspective views for the hopper wall 2 arranged in the working position, whereas FIGS. 5 and 6 show different perspective views for the hopper wall 2 arranged in the transport position.

Reference is made below to FIGS. 7 to 14, in which the structure of the hopper wall adjusting device 3 is shown. As shown, for example, in FIGS. 7 to 9, the hopper wall adjusting device 3 comprises a drive device 6 movably mounted on the at least one frame 4 and a lever system 7 designed to move the associated hopper wall 2. The lever system 7 is pivotably mounted on the frame 4 and is additionally connected to the hopper wall 2. The drive device 6 is pivotably mounted on the frame 4 with one of its longitudinal ends. Furthermore, the drive device 6 is designed as a hydraulic cylinder 8 and is motion-coupled to the lever system 7, wherein “motion-coupled” is to be understood in the sense that the drive device 6 is drive-connected to the lever system 6 and moves the lever system 6. The lever system 7, which is moved by means of the drive device 6, is movably mounted on the frame 4 in a self-locking position (see, for example, FIG. 15) and in a folding position (see, for example, FIG. 20). Consequently, the drive device 6 is designed to move the lever system 7 into the self-locking position and/or into the folding position. In the folding position of the lever system 7, the hopper wall 2 is arranged in the transport position, wherein the lever system 7 assumes a compact position in the folding position that requires little installation space. In the self-locking position of the lever system 7, the hopper wall 2 is arranged in the working position, wherein the lever system 7 is designed to hold the hopper wall 2 in the working position in a self-locking manner. This can be a static self-locking of the lever system 7, which maintains the self-locking position as long as no force acts on the lever system 7. The acting force comes solely from the drive device 6, which moves the lever system 7 from the self-locking position into the folding position. In the self-locking position, it should be noted that the hopper wall 2 has its own weight, wherein in the working position the hopper wall 2 is designed to urge the lever system 7 into the self-locking position with its own weight. Furthermore, the lever system 7 is designed to exceed an extended position when moving from the self-locking position to the folding position or from the folding position to the self-locking position. The extended position of the lever system 7 represents a special position in which lever elements of the lever system 7 are arranged in a line. When the extended position is exceeded, a self-locking effect of the lever system 7 occurs, particularly in the self-locking position. For safety reasons, the lever system 7 has a resistance element 9, which is shown, for example, in FIGS. 13 and 14 and which is designed to allow the extended position to be exceeded against a resistance force exerted by the resistance element 9.

From the overview of FIGS. 7 to 20 it can be seen that the drive device 6 and the lever system 7 are arranged between two side walls of the frame 4. The lever system 7 has a first lever element 10 and a second lever element 11, wherein the first lever element 10 and the second lever element 11 are designed to be movable relative to one another. Furthermore, the first lever element 10 and the second lever element 11 are connected to one another in an articulated manner via a hinge axis 12 (see, for example, FIGS. 8, 15, 17, 19 and 20). The first lever element 10 is connected to the hopper wall 2 by one of its two longitudinal ends, whereas the other longitudinal end of the first lever element 10 is articulated to the second lever element 11 via the hinge axis 12. The second lever element 11 is articulated to the first lever element 10 by one of its two longitudinal ends via the hinge axis 12, whereas the other longitudinal end of the second lever element 11 is pivotably mounted on the frame 4 and articulated to the frame 4. In the self-locking position, the first lever element 10 is arranged at least partially supported on a support 14. The support 14 is formed on the second lever element 11 (see, for example, FIGS. 10 and 11), so that the support 14 for the first lever element 10 is mounted so that it can move with the second lever element 11. In the self-locking position, however, the second lever element 11 can also optionally be supported, as is the case in the embodiment shown in the figures. As can be seen from FIG. 7, in the self-locking position the second lever element 11 is arranged supported on an additional support 15, wherein the additional support 15 is fastened to the frame 4. Consequently, the first lever element 10 and/or the second lever element 11 can be arranged in the self-locking position, at least in sections, supported on respective supports 14 and 15. The support 14 can further be adjustably attached to the second lever element 11 or, as shown in the exemplary embodiment, the distance to the support 14 can be changed by means of adjusting screws 16, which are arranged on the first lever element 10 and are arranged opposite the support 14 in the self-locking position.

As can be seen from the combination of FIGS. 12 to 20, the first lever element 10 is adjustable in its longitudinal extent 17 (see, for example, FIG. 14). For this purpose, the first lever element 10 is designed in several parts with a head part 18 and a foot part 19. The head part 18 is connected at one longitudinal end to the hopper wall 2, whereas one longitudinal end of the foot part 19 is connected to the hinge axis 12 in an articulated manner. The first lever element 10 further comprises a coupling bushing 20 which is fastened to the other longitudinal end of the foot part 19. The head part 18 is bolt-shaped and penetrates the coupling bushing 20, wherein the longitudinal end of the head part 18 penetrating the coupling bushing 20 has a thread onto which a retaining nut 21 is screwed. A movement bushing 22 is inserted into the hollow coupling bushing 20, which is stepped on the inside, as can be seen, for example, in the sectional view of FIG. 14. The bolt-shaped head part 18 also extends through the movement bushing 22 and penetrates it, wherein on the side of the coupling bushing 20 facing away from the retaining nut 21, a further retaining nut 23 is screwed onto the head part 18, which is supported on the movement bushing 22. The movement bushing 22 inserted into the coupling bushing 20 rests within the coupling bushing 20 on an elastically deformable counterforce element 24, so that the head part 18 is held movably against the counterforce of the counterforce element 24 in the direction of the foot part 19. In this way, the first lever element 10 is designed to be adjustable in its longitudinal extent 17. A change in the longitudinal extent 17 is necessary for a movement of the hopper wall 2 and for the lever system 7 so that the lever system 7 can pass through the extended position or the first lever element 10 and the second lever element 11 can pass through a dead center. Thus, during a movement from the self-locking position into the folding position and/or from the folding position into the self-locking position, the first lever element 10 and the second lever element 11 are designed to exceed the dead center or the extended position. The arrangement of the lever system 7 with its first lever element 10 and its second lever element 11 in the dead center or in the extended position is shown in FIG. 17, in which the first lever element 10 and the second lever element 11 are arranged in line and forming a straight line. FIG. 18 shows an enlarged sectional view for this dead center position, from which it can be seen that the bolt-shaped head part 18 is arranged displaced in the direction of the foot part 19, so that a gap 25 is formed between the retaining nut 23 and the coupling bushing 20. The movement of the partition wall 2 from the working position to the transport position and from the transport position to the working position is effected by means of the drive device 6. The drive device designed as a hydraulic cylinder 8 acts on a hinge point which corresponds to the hinge axis 12, via which the first lever element 10 and the second lever element 11 are connected to one another in an articulated manner. When passing through the extended position or the dead center, the head part 18 is displaced against the counterforce of the counterforce element 24 in the direction of the foot part, as shown in FIG. 17. In FIG. 15, the partition wall 2 is arranged in the working position and the lever system 7 is arranged in the self-locking position.

Thus, the first lever element 10 has a counterforce element 24 which is designed to allow the dead center to be exceeded during a movement from the self-locking position into the folding position and/or from the folding position into the self-locking position against the counterforce exerted by the counterforce element 24. The counterforce element 24 is designed such that it allows an adjustment of the longitudinal extent 17 of the first lever element 10 against the counterforce exerted by the counterforce element 24. The counterforce element 24 has an elastic spring element 26.

As can be seen from the enlarged sectional view of FIG. 16, in this arrangement the retaining nut 23 is arranged adjacent to the coupling bushing 20, so that no gap is formed and the first lever element 10 has its maximum longitudinal extent 17, which is greater than at the dead center (see FIG. 18). FIG. 19 shows an arrangement in which the lever system 7 has just passed through the extended position or dead center and is moving towards the folding position shown in FIG. 20. Even in the position shown in FIG. 19 and in the folding position, the retaining nut 23 is arranged adjacent to the coupling bushing 20, as shown in FIG. 16. Thus, the first lever element 10 has a greater longitudinal extent 17 in the self-locking position and in the folding position than in the dead center. In the folding position, the first lever element 10 and the second lever element 11 are folded together and arranged to have an included angle 27 of less than 90° (see FIG. 19). Finally, it is clear from the combination of FIGS. 15, 17, 19 and 20 that during a movement from the folding position into the self-locking position and/or from the self-locking position into the folding position, a direction of rotation 28 of the first lever element 10 is opposite to a direction of rotation 29 of the second lever element 11.

FIGS. 21 to 24 show optional embodiments of the feed hopper 1 according to the invention, wherein these embodiments relate to locking means 30 which are designed to additionally hold and stabilize the hopper walls 2 in the working position. The locking means 30 in FIGS. 21 to 24 have in common that they are constructed in two parts, are arranged on side edges 31 of two adjacent hopper walls 2 and are in engagement with one another in the working position of the hopper walls 2. FIGS. 21 and 22 show an embodiment of locking means 30 which are designed in the manner of a bolt. Two locking pins 33 are movable along the side edge 31 of a hopper wall 2 via a lever mechanism 32, wherein the two locking pins 33 are moved in opposite directions when the hopper walls 2 are arranged in the working position. During this opposite movement, the two locking pins 33 each enter locking pin receptacles 34, which are formed and arranged on the side edge 31 of the adjacent and bordering hopper wall 2, and engage with the locking pin receptacles 34. By contrast, FIGS. 23 and 24 show an embodiment of locking means 30 which are designed in the manner of a catch hook. For this purpose, a lever mechanism 32 is also provided on a side edge 31 of a hopper wall 2, with the aid of which multiple catch hooks 35 can be moved in the direction of the side edge 31 of the adjacent hopper wall 2 or moved back from the adjacent hopper wall 22. Locking pins 33 are arranged on the side edge 31 of the adjacent hopper wall 2, wherein only in FIG. 24 is such a locking pin 33 shown for a section through a locking pin holder 36 (a total of three locking pin holders 36 with three locking pins 33 are provided for the three catch hooks 35). In FIGS. 23 and 24, it is shown that the hopper walls 2 are arranged in the working position, wherein the lever mechanism 32 has already moved the catch hooks 35 in the direction of the adjacent hopper wall 2, wherein the catch hooks 35 are in engagement with the locking pins 33. With the aid of the locking means 30 according to FIGS. 21 to 24, a reliable corner locking for adjacent hopper walls 2 can be realized.

Finally, FIG. 25 shows a development of the hopper wall adjusting device 3 according to the invention. In the hopper wall adjusting device 3 shown in FIG. 25, a safety stop 37 is arranged and fastened to the frame 4. The safety stop 37 is L-shaped with two legs, one leg of the safety stop 37 being fastened to the frame 4 and the other leg being designed to serve as a stop wall. The safety stop 37 is designed to support the hopper wall 4 if the lever system 7 should no longer hold the operating position of the hopper wall 4 due to excessive stress, for example. In this case, the hopper wall 4 would continue to rotate in the direction of rotation 29 and would be moved beyond the operating position until the hopper wall 4 rests against the safety stop 37, which then supports the hopper wall 4. The safety stop 37 is intended only as a safety means. In the operating position, the hopper wall 4 is arranged at a distance from the safety stop 37 and is not in contact with the safety stop 37.

Of course, the invention described above is not limited to the described and illustrated embodiment. It can be seen that numerous modifications can be made to the embodiment depicted in the drawing, which are obvious to a person skilled in the art according to the intended application, without leaving the scope of the invention. The invention includes everything that is contained in the description and/or shown in the drawing, including anything that, deviating from the specific embodiment, is obvious to a person skilled in the art.

### LIST OF REFERENCE SIGNS

1 feed hopper
2 hopper walls
3 hopper wall adjusting device
4 frame
5 pivot axis
6 drive device
7 lever system
8 hydraulic cylinder
9 resistance element
10 first lever element
11 second lever element
12 hinge axis
14 support
15 additional support
16 adjusting screws
17 longitudinal extent
18 head part
19 foot part
20 coupling socket
21 retaining nut
22 movement bushing
23 retaining nut
24 counterforce element
25 gap
26 spring element
27 enclosed angle
28 direction of rotation
29 direction of rotation
30 locking means
31 side edge
32 lever mechanism
33 locking pin
34 locking pin receptacle
35 catch hook
36 locking pin holder
37 safety stop

1. A feed hopper for a material processing machine with multiple hopper walls, each of which is movably mounted in a working position, in which the hopper walls are arranged to enable the receiving and feeding of material to be processed, and a transport position, in which the hopper walls are arranged on the material processing machine in a compact, folded-away manner for transport,
wherein each of the hopper walls is assigned at least one hopper wall adjusting device,
wherein the at least one hopper wall adjusting device has at least one frame, a drive device movably mounted on the at least one frame, and a lever system designed to move the associated hopper wall, which lever system is movably mounted on the at least one frame in a self-locking position and a folding position,
wherein the drive device is connected to the lever system in a movement-coupled manner and the drive device is designed to move the lever system into the self-locking position and/or into the folding position, and
wherein in the working position of the hopper wall, the lever system is arranged in the self-locking position and the lever system is designed to hold the hopper wall in the working position in a self-locking manner.

2. The feed hopper according to claim 1, wherein the hopper wall has its own weight and in the working position the hopper wall is designed to urge the lever system into the self-locking position with its own weight.

3. The feed hopper according to claim 1, wherein the lever system is designed to exceed an extended position when moving from the self-locking position to the folding position or from the folding position to the self-locking position.

4. The feed hopper according to claim 3, wherein the lever system has a resistance element which is designed to allow exceeding of the extended position against a resistance force exerted by the resistance element.

5. The feed hopper according to claim 1, wherein the lever system comprises a first lever element and a second lever element,
wherein the first lever element and the second lever element are designed to be movable relative to one another and are connected to one another in an articulated manner, and
wherein the second lever element is connected to the frame in an articulated manner and the first lever element is connected to the hopper wall.

6. The feed hopper according to claim 5, wherein during a movement from the self-locking position into the folding position and/or from the folding position into the self-locking position, the first lever element and the second lever element are designed to exceed a dead center.

7. The feed hopper according to claim 5, wherein the first lever element is designed to be adjustable in its longitudinal extent and the first lever element has a greater longitudinal extent in the self-locking position and in the folding position than in the dead center.

8. The feed hopper according to claim 7, wherein the first lever element has a counterforce element which is designed to allow the dead center to be exceeded during a movement from the self-locking position into the folding position and/or from the folding position into the self-locking position against a counterforce exerted by the counterforce element.

9. The feed hopper according to claim 8, wherein the counterforce element is designed to allow adjustment of the longitudinal extent of the first lever element against the counterforce exerted by the counterforce element.

10. The feed hopper according to claim 8, wherein the counterforce element comprises an elastic spring element.

11. The feed hopper according to claim 5, wherein the first lever element and/or the second lever element is/are arranged in the self-locking position, supported at least in sections, against a support.

12. The feed hopper according to claim 11, wherein the support is adjustably mounted.

13. The feed hopper according to claim 5, wherein the drive device is designed as a hydraulic cylinder which acts on the first lever element and/or the second lever element.

14. The feed hopper according to claim 5, wherein in the folding position the first lever element and the second lever element are folded together and arranged to have an enclosed angle of less than 90°.

15. The feed hopper according to claim 5, wherein during a movement from the folding position into the self-locking position and/or from the self-locking position into the folding position, a direction of rotation of the first lever element is opposite to a direction of rotation of the second lever element.
